(19) United States
(12) Patent Application Publication
(10) Pub. No.: US 2016/0313553 A1
(43) Pub. Date: Oct. 27, 2016

(54) OPTICAL SCANNER FOR LASER RADAR OR OTHER DEVICES

(71) Applicant: ELECTRONICS AND TELECOMMUNICATIONS RESEARCH INSTITUTE, Daejeon (KR)

(72) Inventors: Jung Ho SONG, Daejeon (KR); Bong Ki MHEEN, Daejeon (KR)

(73) Assignee: ELECTRONICS AND TELECOMMUNICATIONS RESEARCH INSTITUTE, Daejeon (KR)

(21) Appl. No.: 15/085,002

(22) Filed: Mar. 30, 2016

(30) Foreign Application Priority Data
Apr. 22, 2015 (KR) 10-2015-0056651

(51) Int. Cl. G02B 26/10; G02B 13/00

(52) U.S. Cl. CPC G02B 26/101; G02B 13/0005; G02B 26/105; G02B 26/103

(57) ABSTRACT

Provided herein is an optical scanner. The optical scanner includes one or more light sources, a reflector configured to reflect beam reaching from the one or more light sources toward a scan target, an optical lens system including one or more lenses, which are sequentially disposed along a route of the beam between the one or more light sources and the reflector, and a controller configured to control at least one of a movement of the one or more light sources and a movement of the reflector. In the optical lens system, a focal plane is at the one or more light source and an aperture is at the reflector, thereby securing a high scan speed with a small size of the scanner.

### CROSS-REFERENCE TO RELATED APPLICATION

This application claims priority to and the benefit of Korean Patent Application No. 10-2015-0056651, filed on Apr. 22, 2015, in the Korean Intellectual Property Office, the entire contents of which are incorporated herein by reference in their entirety.

### BACKGROUND

1. Field

The present disclosure relates to an optical scanner.

2. Description of the Related Art

A device, which radiates beam emitted from a light source, such as laser, to a specific space in a pattern form, is used in various application fields. For example, there is a device marking characters by using beam of a light source or a radar using laser as a light source.

A laser radar is a device, which obtains a two-dimensional or three-dimensional image by determining distance information about an object by radiating pulse beam, such as laser, to the object and measuring a Time of flight (TOF) of the returning pulse, and determining angular information about the object based on a scan angle of the pulse beam.

The laser radar may include a Galvano scanner for scanning beam. Referring to FIG. 1, a typical Galvano scanner includes a laser 50, a first reflecting mirror 60 reflecting beam of the laser, and a second reflecting mirror 70, which is larger than the first reflecting mirror and reflects the beam reflected from the first reflecting mirror to a specific angle. Referring to FIGS. 1 and 2, the first reflecting mirror 60 reflects the laser beam to the second reflecting mirror 70 while rotating at speed A with respect to a z-axis as a rotation axis. The beam output from the laser is diverged, so that in order to generate parallel beam, a collimator lens may be disposed between the laser 50 and the first reflecting mirror.

FIGS. 1 and 2 illustrate a state, in which the laser beam is reflected to a portion, in which a rotation axis of the second reflecting mirror is laid, by the first reflecting mirror. The first reflecting mirror 60 rotates in an arrow direction and a reflection angle of the beam is sequentially changed to states 61, 62, and 63, and thus the laser beam is reflected like beams 1, 2, and 3 by the rotated first reflecting mirror.

The second reflecting mirror 70 reflects the beams 1, 2, and 3 to a specific space desired to be scanned while rotating at speed B, which is lower than speed A. Referring to FIGS. 1 and 2, the second reflecting mirror 70 is rotated in an arrow direction with respect to an x-axis as a rotation axis and a reflection angle of the beam is sequentially changed to states 71, 72, and 73. When the second reflecting mirror is in the state 71, the beam 1 is reflected like beam 11, the beam 2 is reflected like beam 21, and the beam 3 is reflected like beam 31. When the second reflecting mirror is in the state 72, the beam 1 is reflected like beam 12, the beam 2 is reflected like beam 22, and the beam 3 is reflected like beam 32. When the second reflecting minor is in the state 73, the beam 1 is reflected like beam 13, the beam 2 is reflected like beam 23, and the beam 3 is reflected like beam 33. However, for convenience of the description, in FIGS. 1 and 2, the beam is intermittently illustrated, but it shall be understood that the beam may be intermittently or continuously radiated as necessary.

When the Galvano scanner of FIG. 1 generates a beam pattern in a specific space, a pattern 81 of the beam radiated to a specific region 80 on an x-y plane, which is a part of the beam pattern, is illustrated in FIG. 3. When the second reflecting mirror 70 is rotated at speed B within a range of a predetermined angle while periodically rotating the first reflecting mirror 60 at speed A within a predetermined angle range, the pattern 81 illustrated in FIG. 3 is obtained.

As the number of frames of an image obtained per second is large, the laser radar may obtain a detailed image, so that it is important to rapidly scan a specific region. The first reflecting mirror is relatively smaller than the second reflecting mirror, so that the first reflecting mirror may be rotated at a large speed, but the second reflecting mirror needs to be large so that the beam reflected by the first reflecting mirror to be completely incident, so that the second reflecting mirror becomes heavy and a rotation speed thereof becomes slow.

Accordingly, in order to scan a larger space for a short time, a light source may be added to the Galvano scanner of FIG. 1. Referring to FIG. 4, the two lasers 51 and 52 are disposed with an angle θ1 so as to radiate the beams to a portion of the rotation axis of the first reflecting mirror 60 with different angles. Collimator lenses 91 and 92 are provided between the lasers 51 and 52 and the first reflecting mirror 60. When the laser is added to the Galvano scanner of FIG. 1 in order to improve the scan speed, the two collimator lenses 91 and 92 need to be spaced apart from each other so as to prevent interference between the collimator lenses 91 and 92, so that there is a problem in that a size of the scanner is increased.

Other attempts had been made for radiating beam at a high speed. B. Stann et al. reported the radar performing scanning at a high speed by using one MEMS mirror in the thesis “Brassboard development of a MEMS-Scanned ladar sensor for small ground robots”, Proc. Of SPIE vol. 8037, pp.80371G-1 to 13, 2011”. B. Stann et al. increased a rotation angle by using an optical system because an angle of a rotation of an MEMS mirror is small.

S. Chinn et al. configured the radar having a high scan speed and a small size by vibrating a fiber cantilever in the US Patent Publication No. 2014/0231647 A1, “Compact fiber-based scanning laser detection and ranging system”.

D. Hall configured the radar performing scanning while rotating only in a horizontal direction without scanning in a vertical direction by disposing a plurality of lasers and a plurality of detectors in the U.S. Pat. No. 8,767,190B2, “High Definition Lidar System”.

### SUMMARY OF THE INVENTION

The present disclosure has been made in an effort to solve the above-described problems associated with the prior art, and provides a scanner, which rapidly scans a wide space.

The present disclosure has also been made in an effort to solve the above-described problems associated with the prior art, and provides a compact scanner.

An exemplary embodiment of the present disclosure provides an optical scanner, including: one or more light sources; a reflector configured to reflect beam reaching from the one or more light sources toward a scan target; an optical lens system including one or more lenses, which are sequentially disposed along a route of the beam between the one or more light sources and the reflector; and a controller configured to control at least one of a movement of the one or more light sources and a movement of the reflector, wherein a focal plane of the optical lens system is positioned at the one or more light source and an aperture of the optical lens system is positioned at the reflector.

The focal plane and the aperture may be terms defined when beam is incident into the optical lens system in a reverse direction of the route of the beam.

In the optical lens system, when the beam is incident in a reverse direction of the route of the beam, a distance between a focal point on the focal plane and an optical axis of the optical lens system may be proportional to a focal distance.

The optical lens system may include a first lens in an uppermost stream of the route of the beam and a second lens in a lowermost stream of the route of the beam.

A deflection angle of beam may become larger in proportion to a distance between a position of the one or more light sources and the optical axis of the optical lens system, and the deflection angle of the beam may be defined by an angle between the beam and the optical axis of the optical lens system at between the second lens and the reflector.

The one or more light sources may be disposed so that a center axis of a beam diverged from the light source is perpendicular to the focal plane.

The optical scanner may further include a linear actuator configured to transfer the one or more light sources along a linear transfer axis. The linear transfer axis may be perpendicular to the optical axis of the optical lens system. The controller may control a movement of the one or more light sources by controlling the linear actuator.

The optical scanner may further include a rotation actuator configured to rotate the reflector. A rotation axis of the reflector may be laid in a perpendicular direction to an optical axis of the optical lens system.

The transfer axis may be parallel to the rotation axis.

The one or more light sources may include first and second light sources, which are spaced apart from each other by a predetermined distance.

The linear actuator may simultaneously transfer the first light source and the second light source.

The first light source and the second light source may be disposed in parallel. The first light source and the second light source may be disposed in a direction, which is parallel to the rotation axis or perpendicular to the rotation axis.

The controller may control a movement of the reflector by controlling a driving of the rotation actuator.

The one or more light sources may include one or more laser diodes.

The one or more light sources may include a laser and an optical fiber connected to an output terminal of the laser. The optical fiber may be configured to induce beam emitted from the laser towards the optical lens system.

The linear actuator may transfer the optical fiber.

According to the exemplary embodiment of the present disclosure, a scan speed is improved, so that it is possible to obtain a more detailed scan image.

Further, according to the exemplary embodiment of the present disclosure, it is possible to scan a wide space with a small scanner.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view schematically illustrating a general Galvano scanner.

FIG. 2 is a front view of the Galvano scanner of FIG. 1.

FIG. 3 is a conceptual diagram illustrating a form of a scan pattern by the Galvano scanner of FIG. 1.

FIG. 4 is a perspective view illustrating a case where one light source is further provided in the Galvano scanner of FIG. 1.

FIG. 5 is a perspective view illustrating an optical system according to an embodiment of the present disclosure.

FIG. 6 is a lateral cross-sectional view of an optical lens system of the embodiment of FIG. 5.

FIG. 7 is a lateral cross-sectional view illustrating a passage of beam C of FIG. 6 through the optical lens system in detail.

FIG. 8 is a block diagram illustrating a control system of the embodiment of FIG. 5.

FIG. 9 is a conceptual diagram illustrating an example of a scan pattern generated by the embodiment of FIG. 5.

FIG. 10 is a perspective view illustrating an optical system according to another embodiment of the present disclosure.

FIG. 11 is a block diagram illustrating a control system of the embodiment of FIG. 10.

FIG. 12 is a conceptual diagram illustrating an example of a scan pattern generated by the embodiment of FIG. 10.

FIG. 13 is a conceptual diagram illustrating an example of a scan pattern generated by another embodiment of the present disclosure.

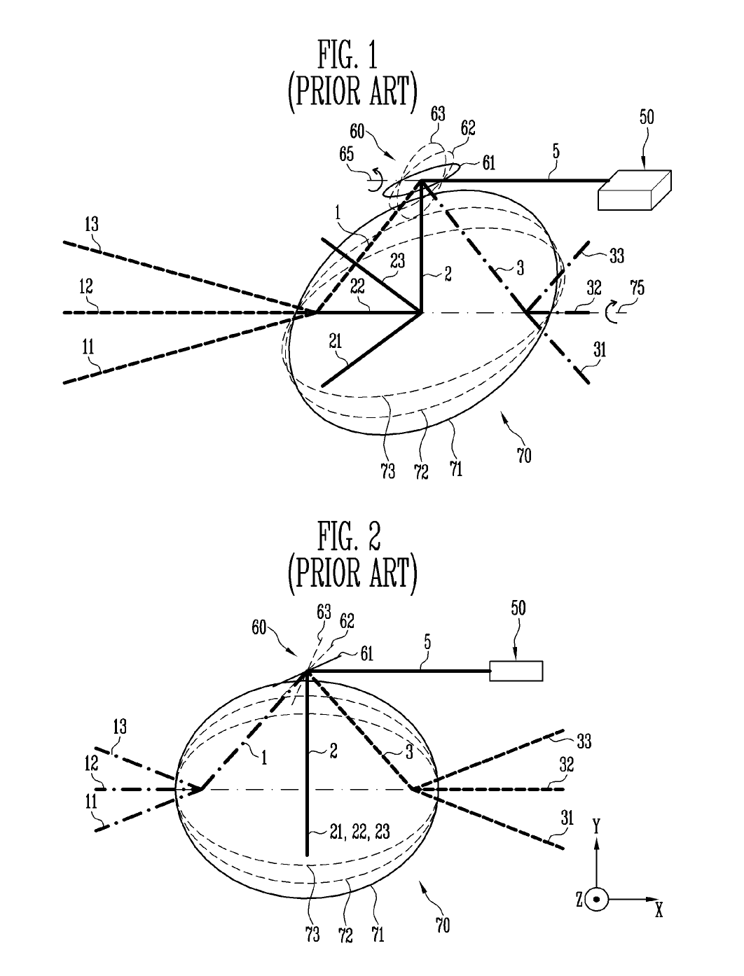

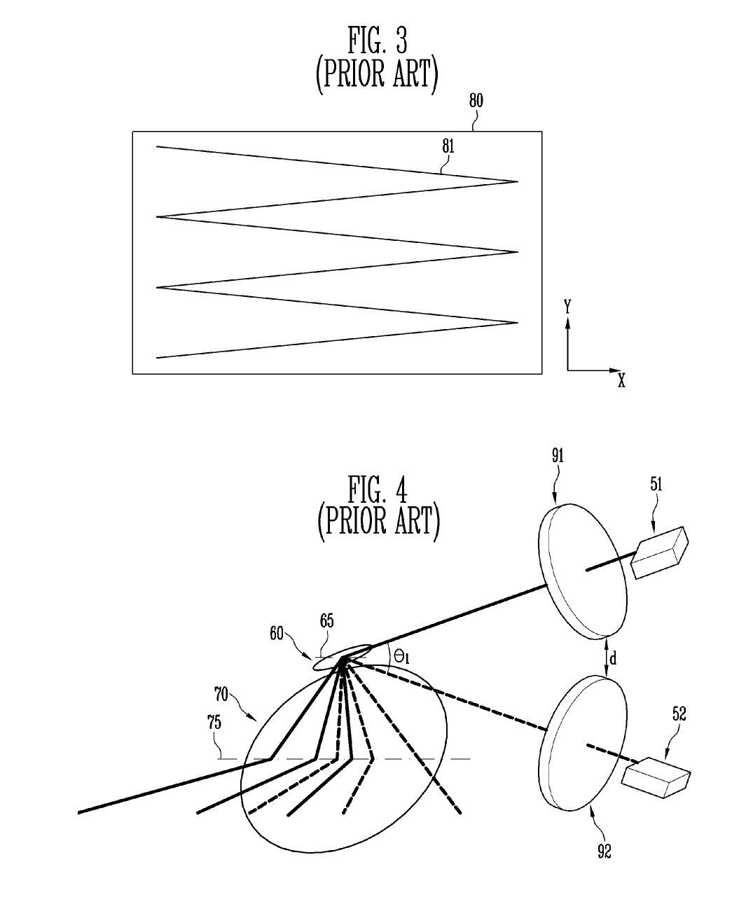

### DETAILED DESCRIPTION OF THE INVENTION

Various advantages and features of the present invention and methods accomplishing thereof will become apparent from the following detailed description of embodiments with reference to the accompanying drawings. However, the present invention is not limited to embodiments disclosed below and may be implemented in various forms, and when one constituent element referred to as being “connected to” another constituent element, one constituent element can be directly coupled to or connected to the other constituent element, but intervening elements may also be present. Further, an irrelevant part to the present invention is omitted to clarify the description of the present invention, and like reference numerals designate like elements throughout the specification.

The embodiments will be described in detail with reference to the accompanying drawings so that those skilled in the art may easily carry out the present invention.

A scanner according to an embodiment of the present disclosure includes a light source 110, a reflector 300 reflecting beam reaching from the light source, an optical lens system 200 disposed between the light source and the reflector, a linear actuator 510 linearly transferring the light source, a rotation actuator 530 rotating the reflector, and a controller 400.

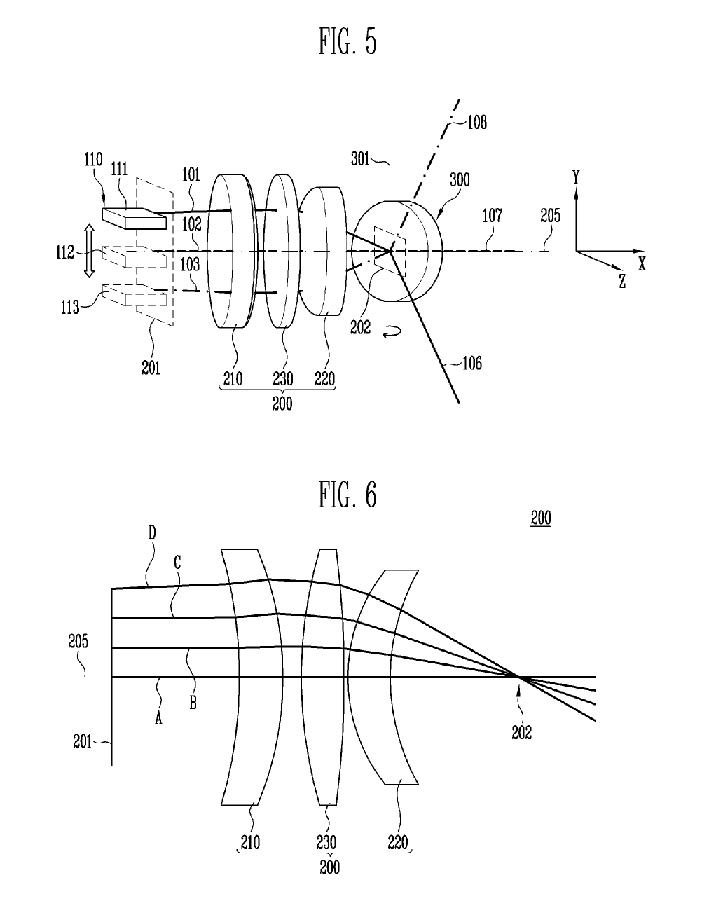

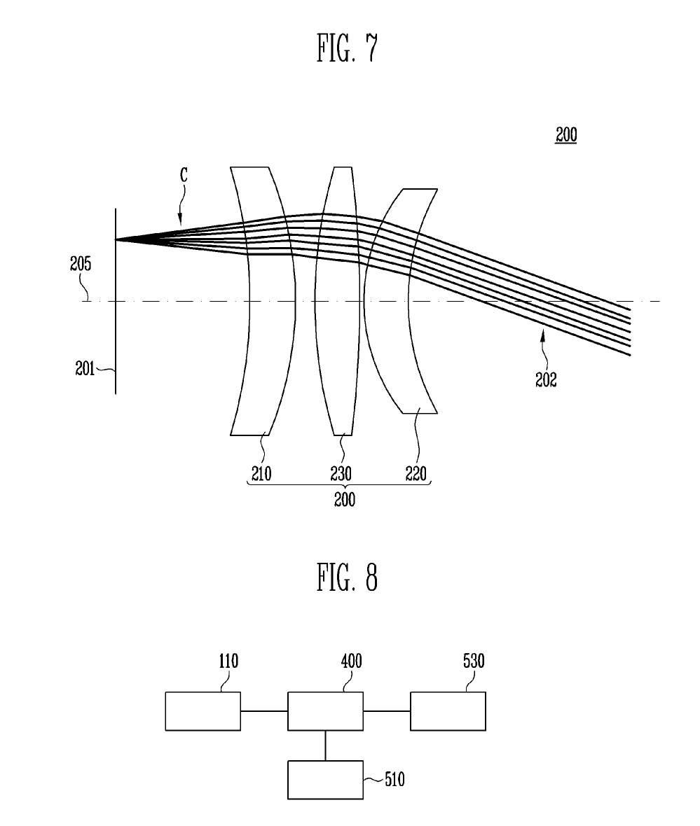

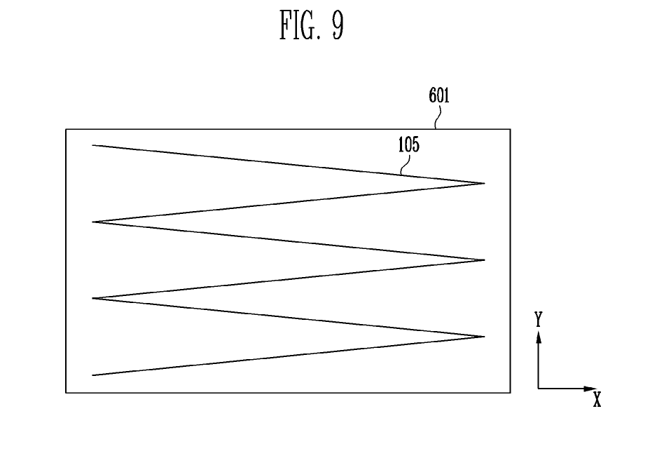

FIG. 5 is a perspective view illustrating an optical system in an embodiment of the present disclosure, and FIG. 8 is a block diagram illustrating a control system in the embodiment of the present disclosure. In FIG. 5, the light source 110 is illustrated as a rectangular parallelepiped object, but is schematically illustrated and is not limited thereto.

The light source 110 includes a laser. Any kind of laser may be accepted as the laser. For example, the laser may be formed of a module, in which a laser diode is buried and is packaged in a form of a small can. The module including the laser diode therein is relatively light, so that the linear actuator 510 may rapidly transfer the module including the laser diode therein.

Otherwise, as another embodiment, the light source 110 may further include an optical fiber, which is connected to an output terminal of the laser and induces beam. When the laser is a relatively heavy solid laser or optical fiber laser, the linear actuator 510 may transfer an end of the optical fiber combined to the output terminal of the laser and increase a transfer speed. Any kind of publicly known optical fiber may be accepted as the optical fiber. Detailed configurations of the laser and the optical fiber are publicly known, so that descriptions thereof will be omitted.

The light source 110 is transferred along a liner transfer axis by the linear actuator 510. The linear actuator 510 transfers the light source 110 in both directions along the transfer axis, and the controller 400 controls the linear actuator 510 to control a movement of the light source. The movement of the light source includes a transfer speed, a transfer distance, a transfer direction, a transfer cycle, and the like of the light source.

The linear actuator 510 transfers the light source 110 in a direction vertical (perpendicular) to an optical axis 205 of the optical lens system 200. That is, the transfer axis of the light source 110 is vertical to the optical axis 205 of the optical lens system. Any kind of publicly known actuator, which linearly moves an object, may be accepted as the linear actuator 510.

Referring to FIG. 5, the optical lens system 200 is disposed between the output terminal of the light source 110 and the reflector 300. In the optical lens system 200, a plurality of lenses is sequentially arranged along an optical route that is a route, along which the beam output from the light source 110 reaches the reflector 300. Hereinafter, for convenience of the description, the route, along which the beam output from the light source 110 reaches the reflector 300, is referred to as a first optical route.

The optical lens system 200 is a telecentric f-theta lens. The f-theta lens refers to a lens, in which a position of focused beam is proportional to a value obtained by multiplying a focal distance f and an incident angle theta. However, the incident angle theta is a term defined when beam is incident into the optical lens system 200 in a reverse direction of the first optical route, and the optical lens system 200 of the present disclosure is arranged so that a focal plane of the telecentric f-theta lens is positioned at the light source 110 side and an aperture is positioned at the reflector 300 side.

When beam incident at an angle of theta passes the f-theta lens and is focused in the aperture, a distance between a position of a focal point on the focal plane and the optical axis of the lens is proportional to the incident angle theta. The telecentric f-theta lens is a lens designed so that beam focused on the focal plane vertically enters the focal planes.

The optical lens system 200 will be described in detail with reference to FIGS. 6 and 7. The optical lens system 200 has a characteristic of the aforementioned telecentric f-theta lens, and the beam of the light source 110 is vertically incident into the focal plane 201. When the light source 110 includes the laser, the laser beam is incident so that a center axis of a divergence angle of the laser beam is perpendicular to the focal plane 201. That is, the light source 110 is disposed so that the center axis of the divergence angle of the laser beam is vertically incident to the focal plane. Here, the divergence angle of the laser beam represents a degree of the spread of the laser beam, and refers to an angle, at which the laser beam is diverged and output at a predetermined angle.

The beam, which is vertically incident to the focal plane 201 of the optical lens system is deflected while passing through the optical lens system, in such a manner that the beam is deflected in proportional to a distance between the optical axis 205 of the optical lens system 200 and a position of the beam on the focal plane. That is, an angle (hereinafter, referred to as “a deflection angle”) between the beam and the optical axis 205 of the optical lens system when the beam is deflected and reaches the aperture 202 of the optical lens system is increased as the position of the beam on the focal plane is far from the optical axis 205 of the optical lens system.

A to D of FIG. 6 illustrate laser beams. In the laser beams A to D, only the beams positioned at a center axis of the diverged beam when the beam is diverged and output from the laser are illustrated.

For example, when the beam vertically incident to the focal plane 201 is A, a distance between the beam A and the optical axis 205 is 0, so that the deflection angle in the aperture 202 is 0. When the beam vertically incident to the focal plane 201 is B, B is further spaced apart from the optical axis 205 than the beam A, so that the beam B is deflected in the aperture 202. In this manner, the deflection angle of the beam C in the aperture 202 is larger than that of the beam B, and the deflection angle of the beam D in the aperture 202 is larger than that of the beam C.

Accordingly, when the light source 110 is transferred in a direction, which is gradually close to the optical axis of the optical lens system, the deflection angle is gradually decreased, and when the light source 110 is transferred in a direction, which is gradually far from the optical axis of the optical lens system, the deflection angle is gradually increased.

FIG. 7 illustrates the beam C in detail, and illustrates a state, in which the beam C is diverged and output from the laser and passes through the optical lens system 200. Even in a case where the beam C is diverged, beam bundles configuring the beam C become parallel beams, which move in parallel to each other while passing through the optical lens system 200, and reach the aperture 202.

In the aspect of the aforementioned configuration, the light source 110 is positioned on the focal plane of the optical lens system 200 and a deflection degree of the beam of the light source is adjusted by adjusting a distance between the light source 100 and the optical axis of the optical lens system, so that it is possible to manufacture a small scanner. Further, since the laser beam passing through the optical lens system becomes a parallel beam, the optical lens system serves as a collimator lens, so that a separate collimator lens for making the diverged laser beam be in parallel is not required.

As an embodiment of the optical lens system 200, the plurality of lenses may include a first lens 210, a second lens 220, and a third lens 230. The first lens 210 is a lens, into which the beam is first incident from the light source 110, and is positioned in a topmost stream of the first optical route. The second lens 220 is a lens, into which the beam is last incident from the light source 110, and is positioned in a lowermost stream of the first optical route. Further, the third lens 230 is disposed between the first lens and the second lens.

The first to third lenses are designed so that the optical lens system has a characteristic of the telecentric f-theta lens, and the focal plane is formed at the first lens side and the aperture is positioned at the second lens side. In the present embodiment, a case where the optical lens system 200 includes the three lenses is illustrated, but the optical lens system is not limited thereto, and any kind of configuration having the characteristic of the telecentric f-theta may be accepted as the optical lens system.

In order to increase the scan speed to be higher with respect to a predetermined transfer speed of the light source 110, the transfer distance of the light source 110 may be short. A transfer distance of the light source for deflecting the beam by theta in the telecentric f-theta lens is obtained by multiplying the focal distance f and the theta (Equation 1 below). Accordingly, when the focal distance f of the telecentric f-theta lens is short, a transfer distance of the light source required for deflecting the beam with a desired theta is decreased.

Transfer distance of light source=f×Θ [Equation 1]

In a case where the beam is desired to be deflected by the desired theta, when the telecentric f-theta lens having a relatively short focal distance f is used as the optical lens system, the transfer distance of the light source 110 is decreased. Accordingly, in a case where a movement speed of the light source 110 is identical, as the focal distance of the telecentric f-theta lens is short, a scan speed is increased. As described above, a scan speed is determined according to a characteristic of the telecentric f-theta lens used in the optical lens system.

The reflector 300 reflects the beam, which is deflected while passing through the plurality of arrays 200, toward a scan target. The beam reaching the reflector 300 is beam deflected by a deflection angle theta with respect to the optical axis 205 of the plurality of arrays in the aperture. The reflector 300 may be a circular plane mirror.

The reflector 300 is periodically rotated within a predetermined angle range, and has a rotation axis 301 perpendicular to the optical axis 205 of the optical lens system 200. Further, the rotation axis 301 of the reflector may be parallel to the transfer direction of the light source 110. The predetermined angle is determined according to a size of the scan target. Referring to FIG. 5, the light source 110 may be transferred in both directions with a y-axis as a transfer axis as denoted by an arrow, and the rotation axis 301 of the reflector 300 may also be parallel to the y-axis. The rotation axis of the reflector 300 may be disposed to be laid at a position of the aperture 202.

A caliber of the reflector 300 may be determined regardless of a size of the scan target. The reasons is that even though the caliber of the reflector 300 is small, it is possible to scan a wide range according to the characteristic of the optical lens system 200 and the characteristic of the light source 110. That is, in the scanner according to the embodiment of the present disclosure, a size of a scan target is independent from a size of the caliber of the reflector 300.

For example, even though the caliber of the reflector 300 is small, when a diameter of the optical lens system 200 is increased, it is possible to scan a wider range. That is, when a diameter of the first lens 210 is increased, a distance between the light source 110 and the optical axis 205 of the optical lens system 200 may be further increased, so that a value of the deflection angle theta of the beam in the aperture 202 may also be further increased. Accordingly, it is possible to increase a size of the scan region by increasing a caliber of at least a part of the lenses of the optical lens system 200.

The reflector 300 rotates based on the rotation axis 301 by the rotation actuator 530. The controller 400 controls the rotation actuator 530 and controls a movement of the reflector. The movement of the reflector 300 includes a rotation angle that is a range, within which the reflector is periodically rotated, a speed and a direction when the reflector 300 is rotated by the rotation angle, and a rotation cycle. The reflector reflects the beam to the scan target while being periodically rotated in an arrow direction and an opposite direction to the arrow direction based on the rotation axis 301. Any kind of publicly known actuator, which rotates an object, may be accepted as the rotation actuator 530.

The controller 400 controls driving of the light source 110 in addition to controlling the linear actuator 510 and the rotation actuator 530. However, the controller is not limited thereto, and the light source 110 may also be controlled by a separate controller.

Although not illustrated, the scanner may further include a memory storing a control condition of the controller 400 and the like.

FIG. 9 illustrates an example of a scan pattern generated in a predetermined region 601 of a scan target by the aforementioned embodiment. Referring to FIG. 5, the light source 110 may move in both directions along the transfer axis parallel to the y-axis, and for example, the light source may pass a first position 111 and a second position 112 and be transferred to a third position 113.

When the light source 110 is positioned at the first position 111, the beam reaching the reflector 300 is reflected to the scan target like beam 106. When the light source 110 is positioned at the second position 112, the beam reaching the reflector 300 is reflected to the scan target like beam 107. When the light source 110 is positioned at the third position 113, the beam reaching the reflector 300 is reflected to the scan target like beam 108. When the light source 110 moves along the transfer axis parallel to the y-axis by the aforementioned scheme, the beam is reflected from the reflector 300 and is scanned in the y-axis direction on a y-z plane.

The reflector 300 may be rotated a plurality of number of times with a predetermined cycle based on the rotation axis 301 parallel to the y-axis while the light source 110 is transferred from an upper side to a lower side. The reflector 300 is rotated a plurality of number of times while reciprocating the predetermined angle range. The rotation of the reflector 300 once means that the reflector is rotated in the arrow direction within the predetermined angle range and then is rotated again in the opposite direction of the arrow direction, and returns to an initial position.

When the reflector 300 is rotated based on the rotation axis 301 parallel to the y-axis in a state where the position of the light source 110 is fixed, the beam may be reflected from the reflector 300 and be scanned in the x-axis direction on an x-z plane. Accordingly, when the reflector 300 is repeatedly rotated within the predetermined angle range while the light source 110 is transferred along the y-axis, a zigzag scan pattern 105 is generated on the x-y plane as illustrated in FIG. 9.

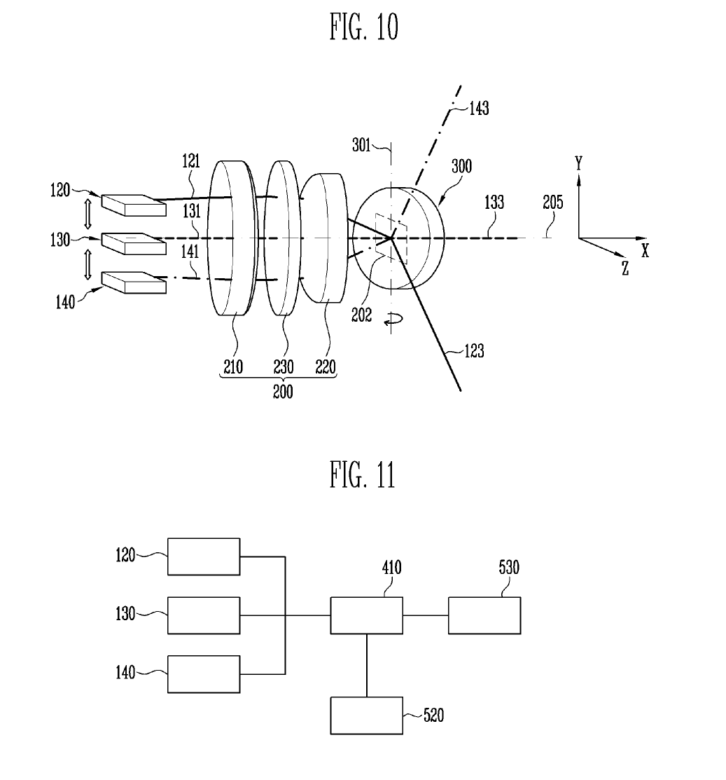

FIG. 10 is a perspective view illustrating an optical system according to another embodiment of the present disclosure, and FIG. 11 is a perspective view illustrating a control system of the embodiment of FIG. 10. The scanner according to another embodiment of the present disclosure includes a plurality of light sources 120, 130, and 140, a reflector 300 reflecting beam reaching from the light source, an optical lens system 200 disposed between the plurality of light sources and the reflector, a linear actuator 520 linearly transferring the plurality of light sources, a rotation actuator 530 rotating the reflector, and a controller 410.

The reflector 300, the optical lens system 200, the rotation actuator 530 are the same as those described with reference to FIGS. 5 to 8, so that detailed descriptions thereof will be omitted, and the same reference numerals are assigned in the drawings.

The plurality of light sources includes first, second and third light sources 120, 130, and 140. The first to third light sources are arranged in parallel along a direction vertical (perpendicular) to an optical axis 205 of the optical lens system 200. Further, the first to third light sources are arranged while being spaced from one another in a direction parallel to a rotation axis 301 of the reflector 300. The first to third light sources 120, 130, and 140 are linearly transferred in an arrow direction by the linear actuator 520.

Beam 121 output from the first light source 120 is deflected in proportional to a distance between the first light source and the optical axis 205 of the optical lens system while passing through the optical lens system 200, and is reflected by the reflector 300 like beam 123. Similarly, beam 131 output from the second light source 130 is reflected like beam 133, and beam 141 output from the third light source 140 is reflected like beam 143.

The linear actuator 520 transfers the first to third light sources 120, 130, and 140 at the same time, and the controller 410 controls movements of the first to third light sources by controlling the linear actuator 520. However, the present disclosure is not limited thereto, the linear actuator may be provided in each of the first to third light sources, and the controller 410 may also control each linear actuator.

The controller 410 may control the linear actuator 520 and the rotation actuator 530, and control operations of the first to third light sources 120, 130, and 140. Further, each of the first to third light sources may include a laser like the light source 110 of the embodiment of FIG. 5, or include a laser and an optical fiber.

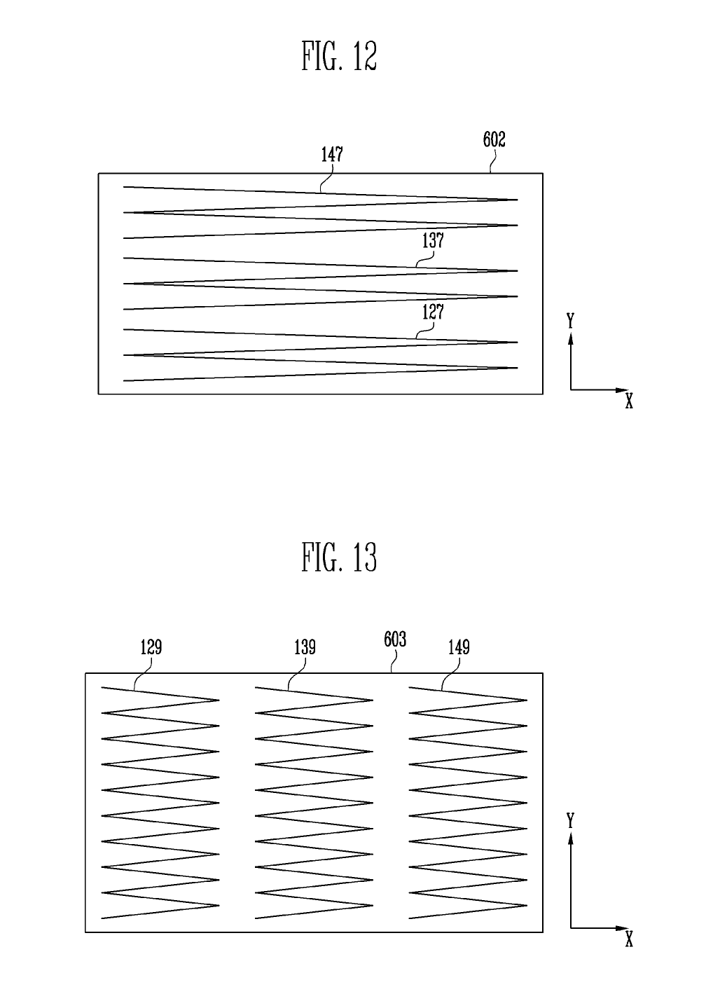

FIG. 12 illustrates an example of a scan pattern generated in a predetermined region 602 of a scan target by the embodiment of FIG. 10. When the reflector 300 is reciprocatingly rotated a plurality of number of times while the first to third light sources are transferred in a predetermined direction along the transfer axis, beam output from the first light source 120 becomes a scan pattern 127, beam output from the second light source 130 becomes a scan pattern 137, and beam output from the third light source 140 becomes a scan pattern 147.

In the aspect of the aforementioned configuration, three light sources are provided, so that there is an effect in that when the light source is controlled under the same condition as that of the embodiment of FIG. 5, a scan speed is increase three times the scan speed of the embodiment of FIG. 5.

In the embodiment of FIG. 10, three light sources are provided, but the present disclosure is not limited thereto, and two light sources may be provided and four or more light sources may be provided as necessary. Further, in the embodiment of FIG. 10, the plurality of light sources is arranged in parallel in the y-axis direction, which is parallel to the rotation axis of the reflector, but the disposition of the plurality of light sources is not limited thereto.

The plurality of light sources is disposed in parallel, and may also be vertically disposed to the rotation axis 301 of the reflector in a row. FIG. 13 illustrates a scan pattern generated in an embodiment, in which the first to third light sources are arranged in a row along with a direction perpendicular to the optical axis of the optical lens system and perpendicular to the rotation axis 301 of the reflector. That is, the first to third light sources may be disposed in a row while being spaced apart from each other along the z-axis.

When the first to third light sources are sequentially disposed along the z-axis and are transferred in the y-axis, and the reflector 300 is repeatedly rotated several number of times with a predetermined cycle within a predetermined angle range, scan patterns 129, 139, and 149 are generated in a predetermined region 603 of the scan target.

In addition, the number of light sources and the disposition of the light sources, such as the arrangement of four light sources in 2×2, may be variously modified according to a targeted scan speed and size of a scan target, a diameter of the optical lens system, and the like.

In the detailed description of the present invention, the particular embodiment has been described, but various modifications are available without departing from the scope of the present invention. Therefore, the scope of the present disclosure is not limited to the embodiments described, but shall be defined by the claims to be described below and the equivalents to the claims.

What is claimed is:

1. An optical scanner, comprising:
one or more light sources;
a reflector configured to reflect beam reaching from the one or more light sources toward a scan target;
an optical lens system including one or more lenses, the one or more lenses are sequentially disposed along a route of the beam between the one or more light sources and the reflector; and
a controller configured to control at least one of a movement of the one or more light sources and a movement of the reflector,
wherein a focal plane of the optical lens system is positioned at the one or more light source and an aperture of the optical lens system is positioned at the reflector.

2. The optical scanner of claim 1, wherein the focal plane and the aperture are defined when beam is incident into the optical lens system in a reverse direction of the route of the beam.

3. The optical scanner of claim 2, wherein the optical lens system is configured such that a distance between a focal point on the focal plane and an optical axis of the optical lens system is proportional to a focal distance.

4. The optical scanner of claim 3, wherein the optical lens system includes:
a first lens in an uppermost stream of the route of the beam; and
a second lens in a lowermost stream of the route of the beam,
wherein a deflection angle of beam becomes larger in proportion to a distance between a position of the one or more light sources and the optical axis of the optical lens system, and
wherein the deflection angle of the beam is defined by an angle between the beam and the optical axis of the optical lens system at between the second lens and the reflector.

5. The optical scanner of claim 1, wherein the one or more light sources are disposed so that a center axis of a beam diverged from the light source is perpendicular to the focal plane.

6. The optical scanner of claim 1, further comprising a linear actuator configured to transfer the one or more light sources along a linear transfer axis,
wherein the linear transfer axis is perpendicular to the optical axis of the optical lens system, and
wherein the controller controls a movement of the one or more light sources by controlling the linear actuator.

7. The optical scanner of claim 6, further comprising a rotation actuator configured to rotate the reflector,
wherein a rotation axis of the reflector is laid in a perpendicular direction to an optical axis of the optical lens system.

8. The optical scanner of claim 7, wherein the transfer axis is parallel to the rotation axis.

9. The optical scanner of claim 6, wherein the one or more light sources include first and second light sources, and
wherein the first light source is spaced apart from the second light source.

10. The optical scanner of claim 9, wherein the linear actuator simultaneously transfers the first light source and the second light source.

11. The optical scanner of claim 9, further comprising a rotation actuator configured to rotate the reflector,
wherein a rotation axis of the reflector is laid in a perpendicular direction to an optical axis of the optical lens system, and
wherein the first light source is spaced apart from the second light source in a direction being parallel to the rotation axis.

12. The optical scanner of claim 9, further comprising a rotation actuator configured to rotate the reflector,
wherein a rotation axis of the reflector is laid in a perpendicular direction to an optical axis of the optical lens system, and
wherein the first light source is spaced apart from the second light source in a direction being perpendicular to the rotation axis.

13. The optical scanner of claim 7, wherein the controller controls a movement of the reflector by controlling a driving of the rotation actuator.

14. The optical scanner of claim 11, wherein the controller controls a movement of the reflector by controlling a driving of the rotation actuator.

15. The optical scanner of claim 12, wherein the controller controls a movement of the reflector by controlling a driving of the rotation actuator.

16. The optical scanner of claim 6, wherein the one or more light sources include one or more laser diodes.

17. The optical scanner of claim 6, wherein the one or more light sources include:
a laser; and
an optical fiber connected to an output terminal of the laser and configured to induce beam emitted from the laser towards the optical lens system,
wherein the linear actuator transfers the optical fiber.
